(19) United States
(12) Patent Application Publication
(10) Pub. No.: US 2009/0192945 A1
(43) Pub. Date: Jul. 30, 2009

(54) Service marketplace system

(75) Inventors: David Perpina, Bamberg (DE); Maik Greubel, Eltmann (DE)

Correspondence Address: Lionos GmbH, Dr.-Martinet-Str. 1, Bamberg, 96049, omitted

(73) Assignee: Lionos GmbH, Bamberg (DE)

(21) Appl. No.: 12/021,608

(22) Filed: Jan. 29, 2008

(51) Int. Cl. G06Q 30/00

(52) U.S. Cl. 705/80

(57) ABSTRACT

A service marketplace system is disclosed for searching and finding service orders and offers, governing the negotiations and conclusions of service agreements between a number of service providers and service users, and which includes an after sale support web service interface to promote to sale of goods in remote online shops by offering related services.

An after sale support web service interface allows a remote online shop's proprietor to incorporate an online search for product-related services available at customers' locations offered on the independent service marketplace. The search results may be displayed on the remote online shop's website along with the product offers the services relate to.

Product-related services are mainly assembly, installation, maintenance and repair services for certain products.

### CLAIM TO PRIORITY

This application claims priority under 35 U.S.C. §120 to U.S. Provisional Patent Application No. 11/60,886,954, entitled Service Marketplace System, filed Jan. 29, 2007.

### FIELD OF THE INVENTION

The present invention relates generally to a system for the buying and selling of services of any kind and, more particularly, to a method and system for offering product-related services via a web service incorporated in a remote online shop, as well as a method and system to manage negotiations of price and terms of a service agreement.

### BACKGROUND OF THE INVENTION

It is generally difficult for small and medium businesses as well as private persons to find a suitable service provider if they want to have services quickly and properly done for an adequate price. This problem occurs especially when someone wants to buy a product which needs an especially qualified or at least knowledgeable person to assemble and install and perhaps even maintain or repair the product, for instance more complex sets of furniture or computer hard- and software. The decision to buy such products may depend on whether after sale support in form of product assembly/installation is part of the bargain.

Most online shops selling goods over the internet, which often is their only sales channel, do neither have the staff nor a qualified partner service provider to offer such product-related services as assembly, installation, maintenance or repair at a reasonable price. As a result, customers will in many cases refrain from buying a product, or buy the product from another seller who offers respective services.

Alternatively customers may buy the product, try to assemble or install it by themselves with or without more or less professional help from instruction manuals, internet help forums or knowledgeable acquaintances. Some buyers may have knowledgeable friends to do the installation or assembly for them—but if something goes wrong, those buyers may refrain from claiming damages from their friends, or they may not be legally entitled to claim damages because there is no valid service contract between them and their friends but only a courtesy relationship. A valid service contract with an independent service provider would forestall these legal and social barriers in most cases.

Apart from this more particular problem it is generally difficult to find a suitable, qualified and reliable service provider for a reasonable price in the vicinity of someone in need of services. Relying on personal recommendation is risky, as the person recommending a service provider might be influenced by his relationship to the service provider. Browsing the local yellow pages often only results in arduous telephone calls investigating prices and availability of comparable services. Quality and reliability of a service provider cannot be ascertained in advance this way.

On the other hand, service providers have difficulties receiving assignments because of the overwhelming competitive presence. Because of the shortcomings of the yellow pages described above and because of the geographical restrictions inherent in personal recommendations, the establishment of a strong and healthy reputation attracting more new customers and thus generating revenue is a difficult and protracted process, which leaves small but high-performant entrepreneurs with little chance to compete with established big service companies.

Efforts to remedy these problems have been taken during the course of the last few years by a few internet companies facilitating “reverse auction” systems on internet service market places. These reverse auction systems facilitated these days by internet service market places are all buyer-driven: someone who wants to have a service done publishes an order on the relevant website, describing the service and specifying a maximum price. Service providers may offer to do the job at a lower price. As required by most of such systems, the service provider with the lowest bid or the one chosen by the buyer receives the order. These systems do not take into account that the buyer himself may want to take the initiative and direct his order to a circle of service providers of his choice, and that a service provider may have an interest to publicly offer his services as well, in order to be “found” by buyers, rather than spending valuable working time considering those reverse auctions and drafting proposals.

As for the problem of product-related services, no independent solution which might be integrated into any online shop exists at present which can be used by retailers to render the offered goods more attractive.

### SUMMARY OF THE INVENTION

Generally, according to one aspect of the invention, a service marketplace system is disclosed for searching and finding service orders and offers, governing the negotiations and conclusions of service agreements between a number of service providers and service users.

The service market system is accessible via a service market website on the internet. Service users and service providers may create user profiles containing personal data such as name, address, offered or ordered services, interests and hobbies, professional qualifications, certificates and credentials. Product manufacturers and independent credential certification institutions may award certain service providers with special qualification certificates. Remote retailers and marketing partners may create web service client accounts in order to facilitate their use of an after sale support web service interface. A social network may use an interface to incorporate their network structure into the service marketplace system.

The service marketplace system preferably facilitates a search function for service orders as well as for service offers. The users may refine searches by applying a set of filters, as for instance keywords, product identification numbers, geographical distance, temporal availability, price range, feedback level etc. The distance filtering is facilitated by a geo-localization function which is able to calculate the distance between two sets of various types of geographical location data, such as for instance a postal code.

A transaction system facilitates the pre-contractual negotiations and the contract conclusion between one or more service users and service providers so as to grant the users maximum freedom to make and discuss as many counter offers as they may deem appropriate.

A quality feedback system facilitates the continuous evaluation of the quality and reliability of the service marketplace's members. Premium services liable for fees award specific advantages to the marketplace members.

According to a particular aspect of the invention, an after sale support web service interface promotes the sale of goods in remote online shops by offering related services. Such after sale support web service interface allows a remote online shop's proprietor to incorporate an online search for product-related services available at customers' locations offered on the independent service marketplace. The search results may be displayed on the remote online shop's website along with the product offers the services relate to. Product-related services are mainly assembly, installation, maintenance and repair services for certain products.

### BRIEF DESCRIPTION OF THE DRAWINGS

In order that the advantages of the present invention will be readily understood, a detailed description of the invention will be given by reference to specific embodiments that are illustrated in the appended drawings. These drawings depict only typical embodiments of the invention and are therefore not to be considered to be limiting its scope.

FIG. 1 is a schematic block diagram of a service marketplace system in accordance with one embodiment of the present invention;

FIG. 2 is a schematic block diagram illustrating one embodiment of a search module;

FIG. 3 is a schematic block diagram illustrating one embodiment of geo-localization module;

FIG. 4 is a schematic flow chart diagram depicting an exemplary negotiation and transaction process;

FIG. 5 is a schematic block diagram illustrating one embodiment of a feedback module;

FIG. 6 is a schematic block diagram illustrating one embodiment of a premium service module;

FIG. 7 is a schematic block diagram illustrating one embodiment of a data management module;

FIG. 8 is a schematic flow chart diagram depicting an exemplary web service activation process.

### DETAILED DESCRIPTION

The embodiment of the invention as illustrated is an electronically enabled, internet accessible marketplace for services of any possible kind.

Many of the functional units described in this specification have been labeled as modules, in order to more particularly emphasize their implementation independence.

Modules may be either be implemented as hardware circuits, off-the-shelf-semiconductors or other discrete components, in programmable hardware devices, or in software for execution by various types of processors.

If implemented in software, an identified module of executable code may, for instance, comprise one or more physical logical blocks of computer instructions which may, for instance be organized as an object, procedure or function. Nevertheless, the executables of an identified module need not be physically located together, but may comprise dissimilar instructions stored in different locations which, when joined logically together, constitute the module and achieve the module's purpose.

A module of executable code may be a single instruction, or many instructions, and may even be distributed over several different code segments, among different programs, and across several memory devices. Similarly, operational data may be identified and illustrated herein with modules, and may be embodied in any suitable form and organized within any suitable type of data structure. The operational data may be collected as a single data set, or may be distributed over different locations including over different storage devices, an may exist, at least partially, merely as electronic signals on a system or network. Unless otherwise indicated, a module may comprise a commercially available computer program or specially designed computer software and hardware such as are known in the art.

Reference throughout this specification to “one embodiment” “an embodiment” or similar language means that a particular feature, structure or characteristic described in connection with the embodiment is included in at least one embodiment of the present invention. Thus, appearances of the phrases “in one embodiment”, “in an embodiment”, and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network translations, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the present method. Other steps and methods may be conceived that are equivalent in function, logic or effect to one or more steps, or portions thereof, of the illustrated method. Additionally, the format and symbols employed are provided to explain the logical steps of the method and are understood not to limit the scope of the method. Although various arrow types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

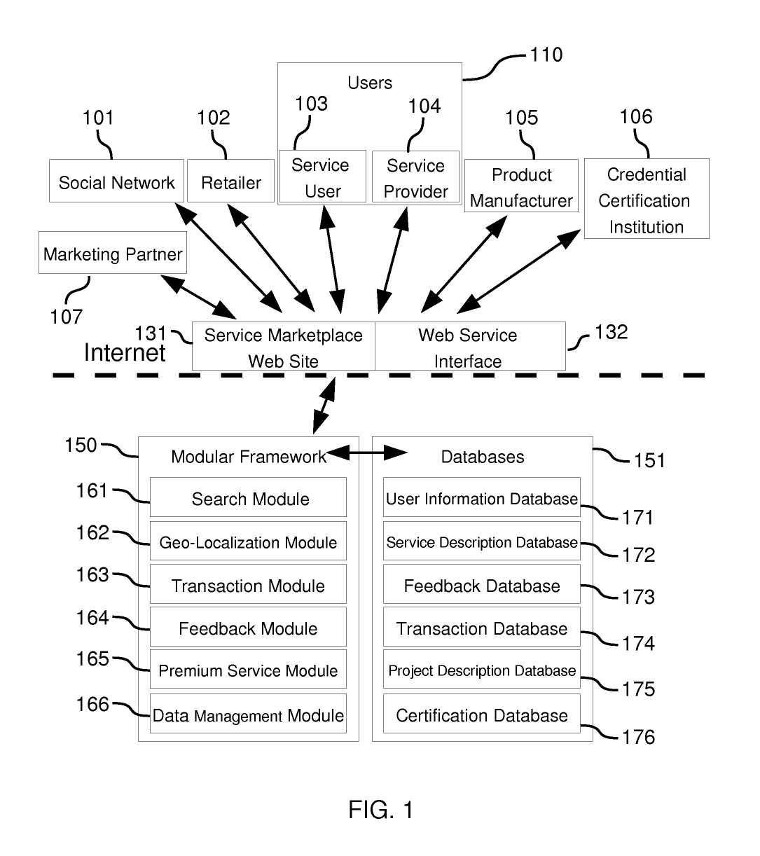

FIG. 1 shows a schematic block diagram illustrating one embodiment of a service marketplace system 100 for governing the negotiations and conclusions of service agreements between a number of service users 103 and service users 104, and for simple integration of service offers into remote websites with a web service interface 132.

A service user 103 may be a natural or legal person wanting to have a service done by another person, for instance a parent looking for a private tutor to teach math to his daughter, or a small business company searching a network specialist to perform network maintenance jobs in given intervals. On the other hand, a service provider 104 may be a natural or legal person offering one or more services, for instance the assembly of furniture, catering services, dance lessons etc.

In a specific embodiment of the invention the service marketplace system 100 features a web service interface 132 which is ideally used for promoting goods for sale by offering related services (e.g. assembly or installation of the bought products) directly at a remote retailer's 102 online shop website. In certain embodiments the web service interface 132 may also be incorporated in a website which does not offer goods for sale, such as a marketing partner website 107. A marketing partner website 107 may be the website of any entity ready to incorporate the web service interface 132 into his internet presence in order to promote the service marketplace, as for instance internet communities, social networks 101, or service users 103 and service providers 104.

According to one embodiment service users 103 may also act as service providers 104 and/or marketing partners 107, and vice versa.

In certain embodiments the service marketplace 100 may also include social networks 101, product manufacturers 105 and credential certification institutions 106. A social network 101 may be any internet service provider organizing its members according to levels of degree of contact. A product manufacturer 101 may be the manufacturer of goods available for sale by his distributors, who in turn may be remote retailers 102. A credential certification institution 106 may be any entity having the generally or partly acknowledged competence to award service providers 104 with certificates deemed relevant to determining the skill, qualification and/or experience in performing the offered services, for instance a national chamber of commerce.

In one embodiment of the present invention, the service market system 100 may make use of a remote social network's 101 network structure by getting access to incorporating the relevant network structure data from the remote social network 101. According to one embodiment, product manufacturers 105 and credential certification institutions 106 may determine conditions for the award of credential certificates to service providers 104. A data management module 166 may populate a certification database 176 with the relevant data. A search module 161 may be configured to search the certification database for service providers 104 bearing a specific credential certificate, thus issuing only results concerning services offered by service providers of special qualification.

The service marketplace system 100 is accessed via a service market website 131. In one embodiment of the present invention, the internet user may access the service market website 131 via any computer terminal featuring an internet connection. In certain embodiments, a computer terminal especially designated to provide access to the service marketplace system 100 may be located at a brick and mortar establishment where people generally tend to be in need of services, for instance a home-improvement market where the proprietor wants to have the offered goods rendered more attractive by offering his customers the possibility to inquire for assembly or installation services.

In a further embodiment, a retailer 102 may integrate the web service interface into their online store in order to promote his goods for sale by giving potential buyers the opportunity to browse available services related to the offered goods. In another embodiment, a retailer 102 may install a computer terminal especially designated to provide access to the service marketplace system 100 at his brick and mortar store.

In one embodiment of the present invention, users 110 communicate with a modular framework 150 through the service marketplace website 131. The modular framework 150 may comprise the following modules:

A search module 161, enabling a user 110 to search for services offered or ordered according to specified search criteria;

A geo-localization module 162 determining the geographical distance between a user 110 and another user 110;

A transaction module 163 governing the pre-contractual negotiations between two or more users 110 and determining whether and when a binding contractual relation between two or more users 110 is entered;

A feedback module 164 allowing a user 110 to award a quality feedback to another user 110 he already dealt with via the service marketplace system 100;

A premium service module 165 providing special services and advantages to a user 110 who was awarded a special premium status in comparison to “standard” users;

A data management module 166 administering the collection, storage and use of data relevant to the service marketplace system 100.

In one embodiment, the modular framework 150 accesses and interacts with the databases 151, which may comprise the following databases:

A user information database 171 containing information about users 110;

A service description database 172 containing information about services offered by service providers 104 or service ordered by service users 103;

A feedback database 173 containing quality feedback information about service agreements that have already been completed;

A transaction database 174 containing any relevant information concerning service agreement negotiations and conclusions;

A project description database 175 containing performance descriptions about carried out services by the contractual parties of a service agreement;

A certification database 176 containing information about credentials verifying a service provider's 104 professional qualification.

In one embodiment, a user 110 accessing the service market website 131 is invited to create a user profile. In the process he may be asked to give information such as his name, address, email-address and user name. He may also enhance his profile by providing further information, for instance about his interests or hobbies, his professional qualification and experience his reachability on the service marketplace etc.

According to one embodiment, a service provider 104 may enter a description of one or more services he is generally willing to perform via the service market website 131. The data management module 166 populates the service description database 172 with the description assigned to the service provider 104, which may then be accessed by any part of a modular framework 150, for instance a search module 161. Vice versa, a service user 103 may populate the service description database 172 with the description of a service he wants to have performed.

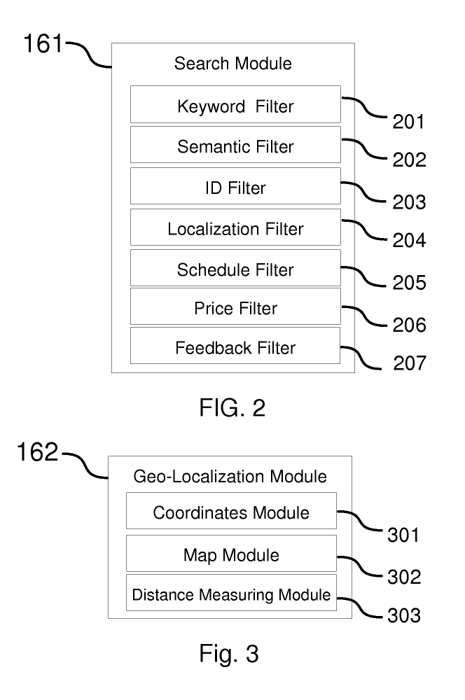

FIG. 2 is a schematic block diagram illustrating one embodiment of a search module 161. According to one embodiment, such search module 161 may be configured to search the databases 151, for instance the project description database 175, for information relevant to a user's 110 request.

In one embodiment of the present invention, a service user 103 may access the search module 161 via the service market website 131 in order to find service providers 104 to perform desired services for him. Vice versa, a service provider 104 may conduct a search for service users 103 wanting to have services done. Vice versa, a service provider 104 may search for service orders of any service users 103.

The search may be based on user 110 input such as price, geographic location, service description, feedback level, temporal availability, credentials and/or social relationship. For example, the search module 161 may search for all master carpenters offering intarsia work within a twenty-mile radius from the searcher at least 99% positive feedback who are still available for hire in the first week of May.

An embodiment of a search module 161 may apply one or more filters to a search request for refining search results, as for instance a keyword filter 201, a semantic filter 202, an ID filter 203, a localization filter 204, a schedule filter 205, a price filter 206 and a feedback filter 207.

A keyword filter 201 narrows searches according to specific keywords determined by the users 110. A semantic filter 202 may be able to process whole sentences. With an ID filter 203 search results may be narrowed according to certain predefined unique identification numbers, for instance product identification numbers or partner identification numbers. A localization filter 204 enables limiting search results to specific geographic locations or regions, by processing information for instance in form of place names, postal codes or geographical coordinates. In combination with the geo-localization module 162, a geographical map showing locations concerning the search results in relation to the searcher's position may be displayed on the service marketplace website 131. A schedule filter 205 may be applied for limiting search results according to the temporal availability of a certain service provider 104. A price filter 206 will limit search results to services offered within a certain price range. A feedback filter 207 may be applied to list only those results where the service provider 104 shows a certain level of positive feedback.

In case a search request delivers one or more search results, the result will be displayed via the service market website 131.

FIG. 3 is a schematic block diagram illustrating one embodiment of geo-localization module 162. Such geo-localization module 162 ideally comprises a coordinates module 301, a map module 302 and a distance measuring module 303.

A coordinates module 301 converts descriptions of geographical locations such as place names, postal addresses or postal codes into geographical coordinates.

A map module 302 uses the coordinates calculated by the coordinates module 301 to display one or more relevant locations on a geographical map on the service market website 131.

A distance measuring module 303 calculates the distance between two relevant sets of coordinates. The user information database 171 may be populated by the data management module 166 with the results of the calculations of the coordinates module 301. According to one embodiment, the search module 161 applying the localization filter 204 may be configured to interact with the distance measuring module 303, thus limiting search results to services requested or offered by users 110 located within a searcher-determined geographical distance in relation to the searcher's own location. In one embodiment, search results may then be displayed by the map module 302 on a geographical map on the service market website 131.

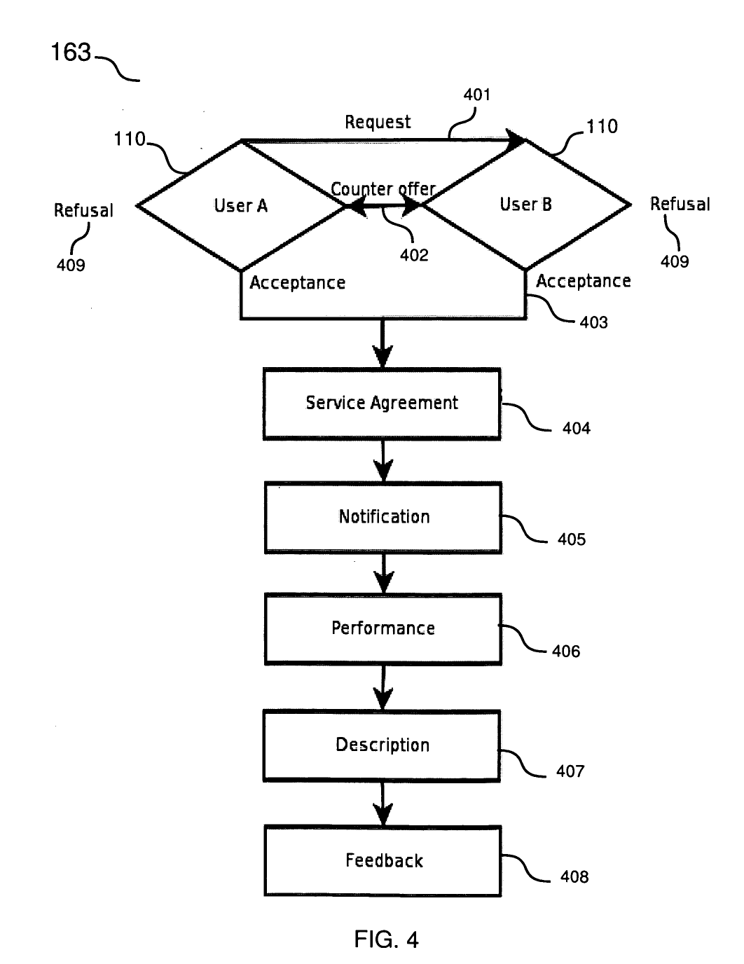

FIG. 4 is a schematic flow chart diagram depicting an exemplary negotiation and transaction process as ideally conducted by the transaction module 163.

In one embodiment of the present invention, a service user 103 may send a request to a number of service providers 104, specifying the service he wants to have done, setting one or more conditions if applicable and a offering a price he is willing to pay for the service. Vice versa, a service provider 104 may send an offer to a service user 103 having specified services they want to have done, specifying conditions a and demanding a price he is willing to do the service for.

In one embodiment of the present invention, a user 110(A) receiving a request 401 from another user 110(B) may send an answer to this request 401, either accepting 403 the service order or offer, making a counter offer 402 by altering the set conditions and/or price, or refusing 409 the request.

In one embodiment of the present invention, each request 401 or counter offer 402 is regarded as a legally binding contract offer. The first user 110 to accept 403 such request 401 or counter offer 402 “as is” without making alterations to either price or conditions will enter a legally binding service agreement 404 with the other party (first come, first served). At the same instant, according to one embodiment, the yet unanswered requests 401 sent to other users or any other counter offers 402 will be revoked or refused 409 either automatically or at the discretion of the user.

In another embodiment, requests 401 and counter offers 402 are not regarded as legally binding, and the user 110 who posted the initial request 401 may choose freely to accept one or more of the returning acceptances 403 or counter offers 402. A legally binding service agreement 404 may then be concluded by confirmation of the acceptance 403 by the other party.

According to one embodiment, after a legally binding service agreement 404 has been concluded, the system will send a notification 405 to each contractual party and provide them with the personal data of the other party. The parties may then both carry out their contractual obligations (406).

After a service agreement has been carried out, or in case it has not been carried out for specific reasons, the users who are parties to such agreement may be invited to give appropriate feedback 408 to the other party.

In another embodiment, the parties are invited to provide a detailed description 407 of the performance. The data management module 166 may populate the project description 407 database with these descriptions, which may in return be accessed by the search module 161 in future searches.

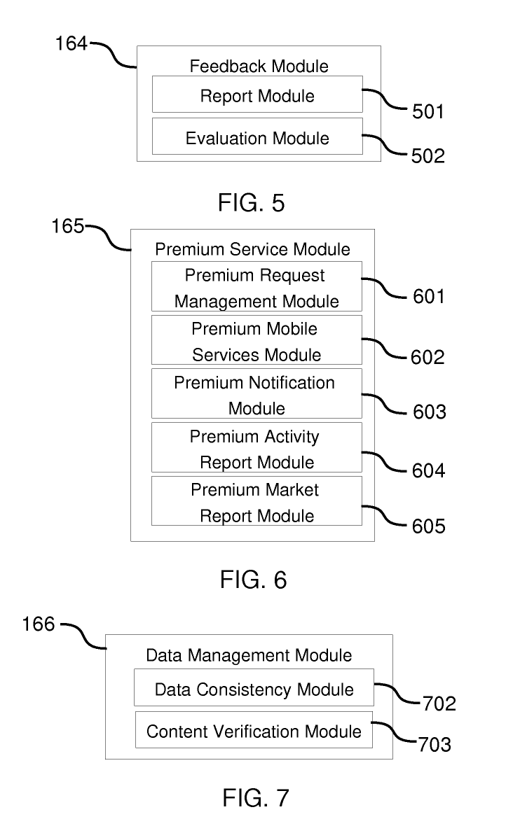

FIG. 5 is a schematic block diagram illustrating one embodiment of a feedback module 164. Such feedback module 164 ideally comprises a report module 501 and a evaluation module 502.

A report module 501 governs the creation of a performance description for a completed service agreement by the users 110 who are parties to the service agreement. According to one embodiment, a service user 103 drafts a detailed description of the services performed. Such draft is submitted to the relevant service provider 104 for a review. The service provider 104 may now either accept the draft description or make alterations and amendments. The revised draft will again be submitted to the service user 103 for approval. This process may be continued for a determined number of times according to certain embodiments of the invention.

An evaluation module 502 allows the parties to a service agreement to award a feedback grade to their contractual partner after a service agreement has been completed. According to one embodiment, feedback may be awarded in form of grades for different aspects of the performance of the contractual obligations and other behaviors of one party as well as a final grade.

FIG. 6 is a schematic block diagram illustrating one embodiment of a premium service module 165.

In one embodiment, a user 110 may be awarded a special premium status in comparison to “standard” users. Reason for awarding such premium status may be, for instance, the payment of premium fees or successful canvass of a predetermined number of new users 110 for the service marketplace. In one embodiment of the present invention, special services and advantages may be provided to a user 110 who is a premium user through the service module 165.

Such premium service module 165 may, for instance, comprise a premium request management module 601, a premium mobile services module 602, a premium notification module 603 and a premium market report module 604.

A premium request management module 601 provides certain premium service providers 104 with a “head start” concerning the receipt of service order requests by service users 103. Such “head start” may be realized by submitting a service user's 103 service order request to premium service providers 104 at once, and a delay in submitting the same requests to non-premium service providers 104 of a predetermined period of time, as for instance one hour. Premium service providers 104 thus have a chance of concluding service agreements before their non-premium competitors gain knowledge of the service order.

A premium mobile services module 602 allows premium users 110 to be notified of relevant events on the service marketplace via a mobile device; for instance an embodiment of a premium mobile services module 602 may notify a premium service provider 104 via his mobile phone that he just received a service request.

A premium notification module 603 is configured to notify a premium service provider 104 that a service user 103 has browsed his user profile and offered services, thus providing him with contact information of a potential customer.

A premium activity report module 604 may provide to a premium service provider 104 a comparison of his activity level on the service marketplace to that of other local competitors offering services in the same field, an displaying his market share compared to the total turn-over on the service marketplace in his field of service.

FIG. 7 is a schematic block diagram illustrating one embodiment of a data management module 166. Such data management module 166 is configured to govern the collection, storage, transfer and use of relevant data, for instance to populate single databases 151 with the relevant data received from user 110 input via the service marketplace website 131. Such data management module 166 ideally comprises a data consistency module 702 as well as a content verification module 703.

A data consistency module 702 is configured to verify the consistency of relevant data and to remove inconsistent data, for instance garbled records, according to one embodiment of the present invention.

A content verification module 703 searches relevant data for unwanted content, for instance illegal content, and may remove such content from the service market website 131 and/or notifies the competent administration staff of service market system 100 of such content.

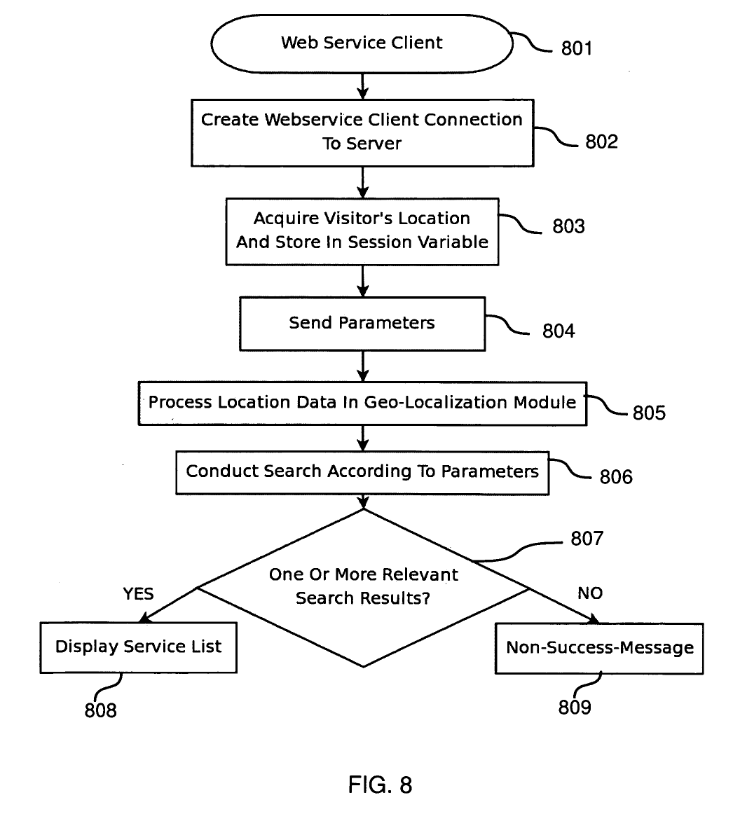

FIG. 8 is a schematic flow chart diagram depicting an exemplary remote web service activation process carried out by the web service interface 132.

In a specific embodiment a remote marketing partner 107 or retailer 102 is invited to incorporate a web service interface 132 into his own web service client 801, for instance a online shop or any website. If a specific action is performed by a visitor of a web service client 801, for instance the selection of a certain product category in an online shop, the marketing partner 107 or retailer 102 may configure his web service client 801 to connect 802 to the web service interface 132.

The web service client 801 may acquire the visitor's location data and send it to the web service interface 132, which will store the location data in a session variable 803. According to one embodiment, a visitor's location data may be acquired, for instance, from the personal data stored in a web service client's 801 user account, if the visitor is logged in at the web service client 801. In another embodiment, the web service client 801 may incorporate a function requesting visitors to provide data concerning their location if they perform a specific action on the web service client 801. In a further embodiment, a web service client 801 may even be configured to address the web service interface 132 without providing any geographical information.

After the visitor's location data has been stored in a session variable, the web service client 801 may be configured to send to the web service interface 132 parameters 804 relevant for a search the remote marketing partner 107 or retailer 102 wants to be conducted in case of the performance of said specific action of the visitor. In one embodiment, the search parameters may be the same parameters used to perform a search directly on the service market website 131, for instance keywords in the service description, a certain price range, a certain distance between the visitor's location and the service provider's 104 location etc.

In another embodiment, prior to the configuration of the web service client, the remote partner 107 or retailer 102 is invited to create a web service client account on the service market website 131, thus being assigned a client identification number. The remote partner 107 or retailer 102 may now assign a search to be performed by the search module 161 to a chosen trigger identification number. According to this embodiment, the parameters sent 804 to the web service interface 132 by the web service client 801 may be the client identification number and the trigger identification number.

According to one embodiment of the present invention, the stored location data 803 may be processed 805 by the geo-localization module 162 to obtain the geographical coordinates of the visitor's location.

Then, according to one embodiment, the web service interface will address the search module 161 to perform a search 806 for offered services according to the parameters 804 (in case the parameters 804 are in form of a client identification number and a trigger identification number, web service client 132 is configured to access the web service client account belonging to the client identification number for the actual search parameters belonging to the trigger identification number.

If the given relevant search parameters include a distance parameter the geo-localization module 162 will limit the search to service providers 104 who are located within the specified distance of the remote web service client's visitor's location.

If the search module 161 finds one or more relevant search results 807, the web service interface 132 is configured to display a list of available services 808 on the remote web service client 801. According to one embodiment of the present invention, if the visitor wants to browse the search results or change the search parameters, he is directed to the service market website 131 by any hyperlink within the search result display.

For instance, an online furniture store has integrated the web service interface 132 into their website and had its website configured to send the trigger identification number “23” to the web service interface 132 whenever a customer browses cupboards. In his web service client account belonging to client identification number “7” on the service market website 131, the store owner has assigned the search keywords “cupboard” and “assembly” as well as a distance filter of “20 miles” to the trigger identification number “23”. Whenever now a customer browses the cupboard section of the online furniture store, he will be notified that there maybe assembly services for cupboards offered near his home address and invited to provide his location either by town or postal code. Upon entering his postal code, the furniture store website will send the postal code to the web service interface 132, which will store it in a session variable, and send the client identification number “7” and the trigger identification number “23” to the web service interface 132. The web service interface 132 will now process the postal code stored in the session variable with the geo-localization module 162 to get the geographical coordinates of the customer, and access the web service client account belonging to the client identification number “7” to get the search keywords “cupboard” and “assembly” and the distance filter of “20 miles” belonging to the trigger identification number “23”. The search module 161 will now conduct a search with the keywords “cupboard” and “assembly”, including only those service providers 104 located 20 miles or less away from the customer. The result of this search—if any—will be displayed within the website the customer has been browsing.

What is claimed is:

1. A method for using a computer to process the promotion and sale of services, comprising:
receiving by said computer information about topics a person is interested in and, if available, information about said person's location;
after receiving said information, querying a database of services offered by a number of service providers to determine which services are related to said topics and, if said person's location has been received, to determine if said services are available at said person's location or within a maximum given distance from that person's location;
offering available services related to said topics to said person;
if said services are not related to said topics, making a general offer to the person that interesting services may be available and inviting the person to conduct a search for available services;
allowing said person to view said service providers' credentials and to negotiate and conclude service contracts with said service providers.

2. The method of claim 1 wherein said topics comprise goods said person wants to buy.

3. The method of claim 2 wherein said information is received from a store where said customer is browsing goods.

4. The method of claim 3 wherein said store is an online store.

5. The method of claim 1 wherein services are only offered to said person if they are available at said person's location or within a maximum given distance from that person's location

6. The method of claim 1, wherein services are only offered to said person if they or the offering service providers meet certain predefined conditions.

7. The method of claim 6, wherein said conditions comprise price, temporary availability of said services and/or credentials of said service providers.

8. A system for processing the promotion and sale of services, comprising:
a memory device storing a program;
a processor in communication with said memory;
said processor operative with said program to:
receive information about topics a person is interested in and, if available, information about said person's location;
after receiving said information, query a database of services offered by a number of service providers to determine which services are related to said topics and, if said person's location has been received, to determine if said services are available at said person's location or within a maximum given distance from that person's location;
offer available services related to said topics to said person;
if said services are not related to said topics, make a general offer to the person that interesting services may be available and invite the person to conduct a search for available services;
allow said person to view said service providers' credentials and to negotiate and conclude service contracts with said service providers.

9. The system of claim 8 wherein said topics comprise goods said person wants to buy.

10. The system of claim 9 wherein said information is received from a store where said customer is browsing goods.

11. The system of claim 10 wherein said store is an online store.

12. The system of claim 8 wherein services are only offered to said person if they are available at said person's location or within a maximum given distance from that person's location

13. The system of claim 8, wherein services are only offered to said person if they or the offering service providers meet certain predefined conditions.

14. The system of claim 13, wherein said conditions comprise price, temporary availability of said services and/or credentials of said service providers.

15. A computer system for processing the promotion and sale of services, comprising:
means for receiving information about topics a person is interested in and, if available, information about said person's location;
means for, after receiving said information, querying a database of services offered by a number of service providers to determine which services are related to said topics and, if said person's location has been received, to determine if said services are available at said person's location or within a maximum given distance from that person's location;
means for offering available services related to said topics to said person;
means for, if said services are not related to said topics, making a general offer to the person that interesting services may be available and inviting the person to conduct a search for available services;
means for allowing said person to view said service providers' credentials and to negotiate and conclude service contracts with said service providers.

16. An article of manufacture comprising:
a computer readable medium comprising instructions for:
receiving information about topics a person is interested in and, if available, information about said person's location;
after receiving said information, querying a database of services offered by a number of service providers to determine which services are related to said topics and, if said person's location has been received, to determine if said services are available at said person's location or within a maximum given distance from that person's location;
offering available services related to said topics to said person;
if said services are not related to said topics, making a general offer to the person that interesting services may be available and inviting the person to conduct a search for available services;
allowing said person to view said service providers' credentials and to negotiate and conclude service contracts with said service providers.
